(19) United States
(12) Patent Application Publication
(10) Pub. No.: US 2026/0238308 A1
(43) Pub. Date: Aug. 13, 2026

(54) SIDELINK INITIAL BEAM PAIRING

(71) Applicant: Apple Inc., Cupertino, CA (US)

(72) Inventors: Chunxuan YE, San Diego, CA (US); Ankit BHAMRI, Bad Nauheim (DE); Dawei ZHANG, Saratoga, CA (US); Haitong SUN, Saratoga, CA (US); Hong HE, San Jose, CA (US); Wei ZENG, Saratoga, CA (US)

(21) Appl. No.: 19/153,701

(22) PCT Filed: Feb. 9, 2024
(86) PCT No.: PCT/US2024/015129

§ 371 Date: Aug. 5, 2025

Related U.S. Application Data
(60) Provisional application No. 63/444,450, filed on Feb. 9, 2023.

(51) Int. Cl. H04B 7/06; H04B 17/318; H04L 1/1812

(52) U.S. Cl. CPC H04B 7/06954; H04B 17/328; H04L 1/1812

(57) ABSTRACT

Methods and systems for performing actions comprising transmitting, from a first user equipment to a second user equipment, a request to establish a sidelink beam pair for unidirectional sidelink communication, the request specifying a sidelink beam reporting format and a sidelink Channel State Information Reference Signal (CSI-RS) configuration; transmitting, from the first user equipment to the second user equipment and based on a measurement of beams at the first user equipment, a message specifying a selected beam, the message including a beam indicator; and activating, at each of the first user equipment and at the second user equipment, the selected beam.

### CLAIM OF PRIORITY

This application claims priority to U.S. Provisional Application No. 63/444,450, filed on Feb. 9, 2023, which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

A base station, such as a next generation node (gNB) can indicate a downlink reference signal such as a synchronization signal block (SSB) or channel state information reference signal (CSI-RS) to provide spatial receiver parameter indication for a user equipment (UE). The SSB or CSI-RS is provided based on a transmission configuration indicator (TCI) state. The gNB can configure a list of TCI states using radio resource control (RRC) signaling. The gNB can activate a number of TCI states using a medium access control (MAC) control element (CE). The UE tracks the number of TCI states and performs receiver beam tracking and time and frequency offset tracking based on the downlink reference signals indicated in the number of TCI states. If the number of activated TCI states is greater than 1, the gNB can indicate a particular TCI state from the number of activated TCI states by downlink control information (DCI).

### SUMMARY

This document describes methods and systems for sidelink (SL) transmissions in a wireless communications network. This document describes sidelink beam management, specifically sidelink initial beam pairing procedures for telecommunication networks such as Fifth Generation (5G) new radio (NR) networks any beyond. The sidelink beam pairing procedures are performed as a part of the beam management that includes the initial beam-pairing, beam maintenance, beam failure recovery, and so forth in a SL-CSI framework. The sidelink beam initial beam pairing procedures described herein can apply to frequency range 2 (FR2) transmissions in which UE-to-UE (sidelink) transmissions are unicast, rather than broadcast or groupcast scenarios.

The processes and systems described herein provide one or more of the following advantages. The Tx UE and the Rx UE are configured to trigger the sidelink beam pairing procedure when the omnidirectional broadcast beam does not satisfy one or more link quality metrics. The sidelink communication between UEs is improved because a poor signal quality between the UEs is quickly detected and the beam pairing procedure is triggered to provide a better quality communication link. The Rx UE sends a sidelink beam pairing request through a data channel. The Rx UE is configured to select a resource for transmission of the sidelink beam pairing request. The Rx UE is configured for failure handling of the beam pairing request. The beam pairing request is the initial beam pairing request, and an antenna selection proceeds after the beam pair is selected by the Tx UE based on the data provided by the Rx UE to the Tx UE.

The request/response approaches to the sidelink beam pairing configuration enables the Rx UE and the Tx UE to set up the beam pair for the directional sidelink link. The request/response procedures described herein are novel for sidelink scenarios. For Uu links (e.g., between a gNB and the UE), SSB-based initial beam pairing is used. In sidelink scenarios, there is no beam management scheme that is defined. The SSB-based initial beam pairing for Uu links is not applicable to sidelink scenarios. For Uu links, the SSB is only transmitted from the base stations. Each UE has beam pairing with the base station. Hence, the SSB only carries cell ID, not a transmitter (e.g., a UE) identifier. For sidelink scenarios, it is possible that every UE can send a S-SSB. Because there are multiple sidelink unicast pairs in the system, a number of S-SSB transmissions is large. The S-SSB does not carry UE identifier in the sidelink design. Thus, a Rx UE does not know whether the S-SSB is transmitted from a given Tx UE. The definitions described herein specify how beam pairing management is performed for sidelink communications.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system that includes sidelink communications, according to some implementations.

FIG. 2 illustrates a flow diagram 200 of an example process 200 for triggering beam pairing procedures.

FIGS. 3A-3B illustrate respective flow diagrams of example processes for initial sidelink beam pairing procedures once the beam pairing procedure is triggered.

FIG. 4 illustrates an example structure of a MAC CE.

FIG. 5 shows an example process for sidelink beam pairing request retransmission.

FIGS. 6A-6B illustrate respective flow diagrams of example processes for exemplary beam pairing procedures that specify how beam indication is performed.

FIG. 7 shows an example process for activation of the paired sidelink beams by the Tx UE and the Rx UE.

FIGS. 8A-8D each illustrates a flowchart of an example method, according to some implementations.

FIG. 9 illustrates an example user equipment (UE), according to some implementations.

FIG. 10 illustrates an example access node, according to some implementations.

### DETAILED DESCRIPTION

The procedures described herein include a process for configuring a beam pairing request by a receiving (Rx) UE and processing the beam pairing request by a transmitting (Tx) UE. The beam pairing request from a Rx UE can be triggered in sidelink scenarios in which a broadcast signal from the Tx UE has a low quality or a low signal strength. The Rx UE is configured to send a request to the Tx UE based on beam metrics measured at the Rx UE. The Tx UE receives the request from the Rx UE, selects a beam, and sends a confirmation to the Rx UE regarding the selected beam. The beam configuration can be done by the Rx UE and the Tx UE using an omnidirectional beam (rather than directional beam) based on different signaling configurations described in detail herein.

The request/response approaches to the sidelink beam pairing configuration enables the Rx UE and the Tx UE to set up the beam pair for the directional sidelink link. The request/response procedures described herein are novel for sidelink scenarios. For Uu links (e.g., between a gNB and the UE), SSB-based initial beam pairing is used. In sidelink scenarios, there is no beam management scheme that is defined. The SSB-based initial beam pairing for Uu links is not applicable to sidelink scenarios. For Uu links, the SSB is only transmitted from the base stations. Each UE has beam pairing with the base station. Hence, the SSB only carries cell ID, not a transmitter (e.g., a UE) identifier. For sidelink scenarios, it is possible that every UE can send a S-SSB. Because there are multiple sidelink unicast pairs in the system, a number of S-SSB transmissions is large. The S-SSB does not carry UE identifier in the sidelink design. Thus, a Rx UE does not know whether the S-SSB is transmitted from a given Tx UE. The definitions described herein specify how beam pairing management is performed for sidelink communications.

The request/response approaches to the sidelink beam pairing configuration enables the Rx UE and the Tx UE to set up the beam pair for the directional sidelink link. The request/response procedures described herein are novel for sidelink scenarios. For Uu links (e.g., between a gNB and the UE), SSB-based initial beam pairing is used. In sidelink scenarios, there is no beam management scheme that is defined. The SSB-based initial beam pairing for Uu links is not applicable to sidelink scenarios. For Uu links, the SSB is only transmitted from the base stations. Each UE has beam pairing with the base station. Hence, the SSB only carries cell ID, not a transmitter (e.g., a UE) identifier. For sidelink scenarios, it is possible that every UE can send a S-SSB. Because there are multiple sidelink unicast pairs in the system, a number of S-SSB transmissions is large. The S-SSB does not carry UE identifier in the sidelink design. Thus, a Rx UE does not know whether the S-SSB is transmitted from a given Tx UE. The definitions described herein specify how beam pairing management is performed for sidelink communications.

The procedures described herein include a process for configuring a beam pairing request by a receiving (Rx) UE and processing the beam pairing request by a transmitting (Tx) UE. The beam pairing request from a Rx UE can be triggered in sidelink scenarios in which a broadcast signal from the Tx UE has a low quality or a low signal strength. The Rx UE is configured to send a request to the Tx UE based on beam metrics measured at the Rx UE. The Tx UE receives the request from the Rx UE, selects a beam, and sends a confirmation to the Rx UE regarding the selected beam. The beam configuration can be done by the Rx UE and the Tx UE using an omnidirectional beam based on different signaling configurations described in detail herein.

The sidelink beam pairing request data configuration is described herein. The Rx UE sends the request on a data channel. The container configuration, content, and formats are described herein. The Rx UE selects a particular resource for sending the sidelink beam pairing request, as described herein. The Rx UE is configured for failure handling if the Rx UE receives no confirmation from the Tx UE regarding the requested sidelink beam pairing.

The Rx UE is configured to select a particular sidelink beam for the beam pairing request. The Rx UE selects a beam based on one or more beam quality metrics measured by the Rx UE. For example, the beam quality metrics can include reference signal received power (RSRP) or one or more other received signal strength indicator (RSSI) measurements. In some implementations, the Rx UE measures values of the beam quality metrics and sends the measured values to the Tx UE, which selects a particular beam based on the data received.

The Rx UE and Tx UE are configured to indicate the selected beam to one another. For example, a UE can send the selected beam indication using a MAC CE, an SCI transmission, and so forth using an omnidirectional beam. Examples are further described herein.

The Rx UE and Tx UE are configured for activation of the configured sidelink beam pair. The activation of a particular beam is based on the received beam indication for the Rx UE and the Tx UE. The activation timing can be pre-defined, preconfigured in the resource pool, configured by RRC signaling, depend on UE capability, or be indicated in sidelink beam reporting/indication messages directly.

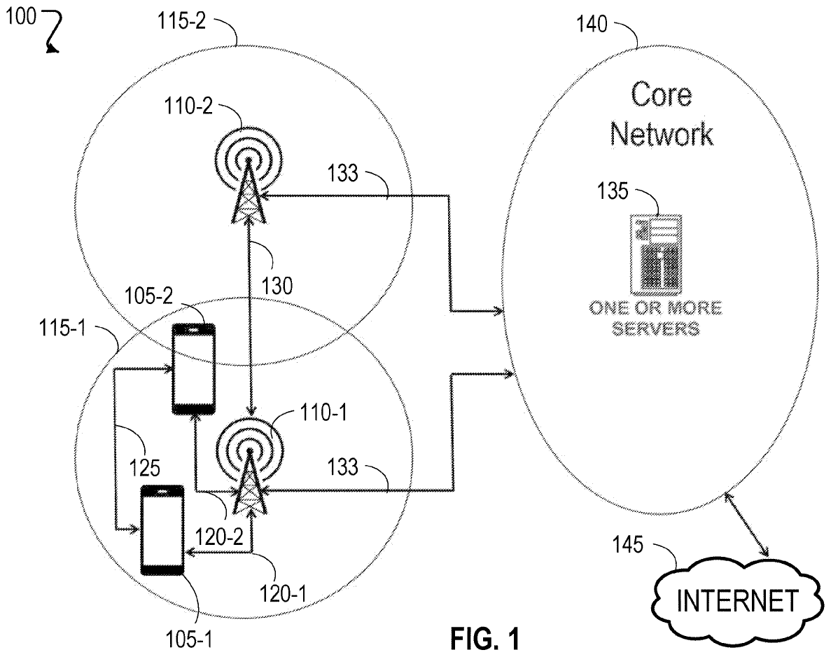

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)), IEEE 802.16 protocols, or the like. While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and road side units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

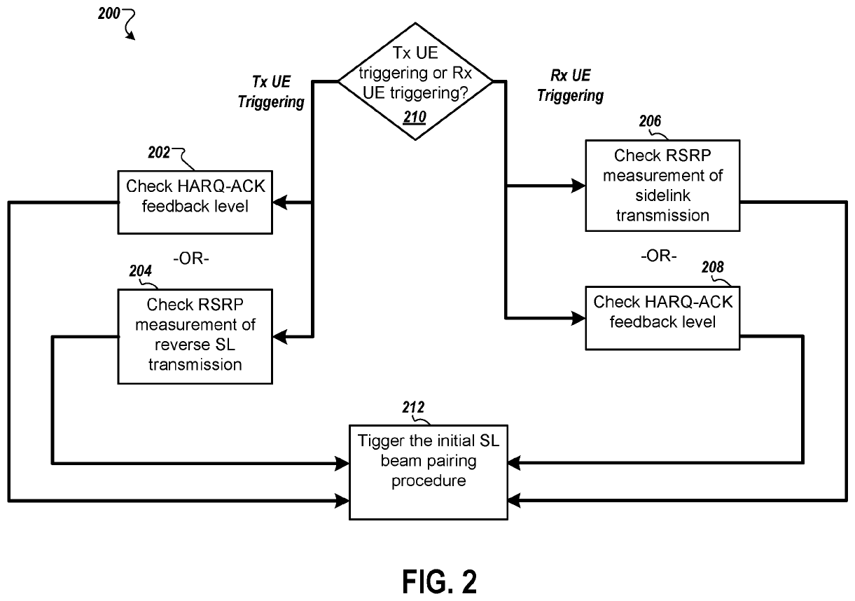

FIG. 2 illustrates a flow diagram 200 of an example process 200 for triggering beam pairing procedures. Each of the Tx UE and the Rx UE can include one of the UEs 105 described previously in relation to FIG. 1. The Tx UE and the Rx UE are in communication with one another in an omnidirectional beam for sidelink communication.

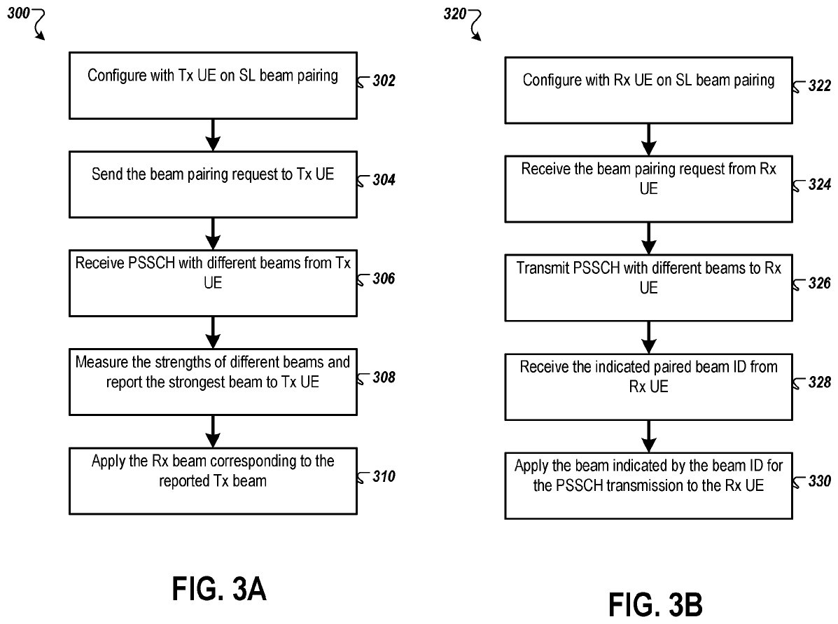

The process 200 is based on one of two cases. In a first case, the Tx UE triggers the initial sidelink beam pairing procedure. In a second case, the Rx UE triggers the initial sidelink beam pairing procedure. The initial beam pairing procedures are described in relation to FIGS. 3A-3B.

FIGS. 3A-3B illustrate respective flow diagrams of example processes 300, 320 for initial sidelink beam pairing procedures once the beam pairing procedure is triggered. Process 300 shows a beam pairing procedure performed by the Rx UE. Process 320 shows a beam pairing procedure performed by the Tx UE once the beam pairing procedure is triggered.

In process 300 of FIG. 3A, the beam pairing is configured (302) with the Tx identified on sidelink beam pairing. The Rx UE sends (304) a beam pairing request to the Tx UE. The Rx UE receives (306) a PSSCH transmission with different identified beams from the Tx UE. The Rx UE measures (308) the strengths of the different beams that are received from the Tx UE. The Rx UE reports the strongest beam back to the Tx UE. The Rx UE applies (310) the receiver beam that corresponds to the reported transmission beam. The process 200 initiates the procedure 300 for selecting the initial sidelink beam pair.

In process 320 of FIG. 3B, the beam pairing is configured (322) with the Rx identified on sidelink beam pairing. The Tx UE receives (324) a beam pairing request from the Rx UE. The Tx UE transmits (326) a PSSCH transmission with different identified beams to the Rx UE. The Tx UE receives (328) an indicated paired beam identifier from the Rx UE. The identifier identifies the selected Tx beam by the Rx UE. The selected beam can be the strongest beam received by the Rx UE or can satisfy one oOr more other criteria. The Tx UE applies (330) the transmission beam that is indicated by the beam identifier for a PSSCH transmission to the Rx UE. The process 200 initiates the procedure 320 for selecting the initial sidelink beam pair.

Returning to FIG. 2, the sidelink triggering case in which the Tx UE causes the triggering to occur is now described. At step 210, a UE Tx triggering scenario is selected or a UE Rx triggering scenario is selected. If the Tx UE transmitting scenario is selected, the process 200 proceeds to step 202. At step 202, the Tx UE checks the hybrid automatic repeat request (HARQ) acknowledgement (ACK) feedback. The Tx UE measures ACK feedback as a percentage of overall feedback of the HARQ-ACK feedback. In some implementations, the Tx UE measures ACK feedback as a total number of responses received in the HARQ-ACK feedback regardless of the total number of requests. If a number or percentage of ACK feedback of the HARQ-ACK feedback does not satisfy a threshold value, the Tx UE triggers the initial sidelink beam pairing procedure at step 212. In another example, if a number or percentage of NACK feedback satisfies or exceeds a threshold number, the Tx UE triggers the initial sidelink beam pairing procedure at step 212. In another example, at step 204, the Tx UE checks the received signal receive power (RSRP) of the reverse sidelink transmission. For example, this sidelink transmission includes the sidelink data transmission from the Rx UE to Tx UE. In this example, the RSRP measurement is performed for the physical sidelink control channel (PSCCH) or physical sidelink shared channel (PSSCH) of the reverse sidelink data transmission. If the RSRP does not satisfy a threshold value, the Tx UE proceeds to step 212 to trigger the initial sidelink beam pairing procedure.

Returning to step 210, the Rx UE transmitting scenario can be selected, and the process 200 proceeds to step 206. At step 206, the Rx UE checks RSRP of the sidelink transmission from the Tx UE. In this example, the Rx UE performs the RSRP measurement for the PSCCH or PSSCH of the data transmission. If the RSRP does not satisfy a threshold value, the Rx UE proceeds to step 212 to trigger the initial sidelink beam pairing procedure. In another example, at step 208, the Rx UE checks the HARQ-ACK feedback to determine whether to trigger the initial sidelink beam pairing procedure. The Rx UE measures ACK feedback as a percentage of overall feedback of the HARQ-ACK feedback. In some implementations, the Rx UE measures ACK feedback as a total number of responses received in the HARQ-ACK feedback regardless of the total number of requests. If a number or percentage of ACK feedback of the HARQ-ACK feedback does not satisfy a threshold value, the Rx UE triggers the initial sidelink beam pairing procedure at step 212. In another example, if a number or percentage of NACK feedback satisfies or exceeds a threshold number, the Rx UE triggers the initial sidelink beam pairing procedure at step 212. At step 212, the Rx UE transmits a sidelink beam pairing request to the Tx UE for the Rx UE based triggering.

The specific process selected for triggering the sidelink beam pairing procedure depends on Tx or Rx UE capability. For example, the selection step 210 can base based on a determination of the capabilities of the Rx UE and Tx prior to determining how the sidelink beam pairing process is to be triggered. In some implementations, the Rx UE-based triggering of steps 206 and 208 or the Tx UE-based triggering of steps 202 and 204 is pre-defined. In some implementations, if the Rx UE has the capability of monitoring the ACK/NACK percentage or monitoring the RSRP measurement of the data transmission, then the Rx UE triggering is used. This also applies to the Tx UE capability. In some implementations, if either the Tx UE or Rx UE has the capability of monitoring the ACK/NACK percentage or monitoring the RSRP measurement of the data transmission, then the UE with the capability could trigger the procedure. In some implementations, if both Tx UE and Rx UE has the capability of monitoring the ACK/NACK percentage or monitoring the RSRP measurement of the data transmission, then the Rx UE and the Tx UE can negotiate on which UE triggers the procedure or both could trigger the procedure.

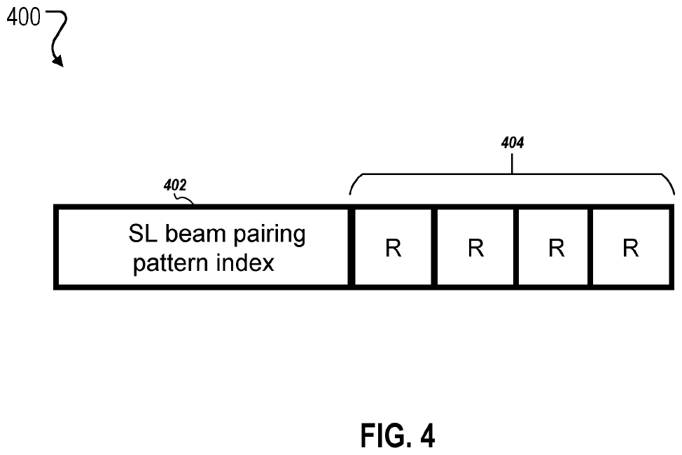

FIG. 4 illustrates an example structure of a MAC CE 400 that is used for a sidelink beam pairing request from the Rx UE to the Tx UE. The design of the sidelink beam pairing request can use the MAC CE 400 or another container for the request as subsequently described. In FIG. 4, the MAC CE 400 includes a sidelink beam pairing pattern index 402 and a set of reserved bits 404.

The design of the sidelink beam pairing request can be enabled or disabled by a resource pool (pre)configuration or by a PC5-RRC configuration. The sidelink beam pairing request container can include the MAC CE 400 that is transmitted over the PSSCH. In another example, the sidelink beam pairing request is included in sidelink control information (SCI) stage 1 messaging. Specifically, the request is included in reserved bits of the SCI stage 1 messaging. In another example, the sidelink beam pairing request is included in SCI stage 2 messaging. The format of the request can be one of Format 2-A, 2-C or 2-D, for example.

The sidelink beam pairing request contents are now described. The sidelink beam pairing pattern index 402 of MAC CE 400 can be one of several patterns of bits that indicate the following information to the Tx UE. The pattern indicates the sidelink beam reporting format. The sidelink beam reporting format can include L1-RSRP/L1-SINR based reporting. The sidelink beam reporting format can include beam identifier based reporting. In some implementations, the format includes a combination of the beam ID and L1-RSRP/L1-SINR formats. The pattern indicates the number of beams to be reported in the request. For example, each of the beams that has an RSRP larger than threshold are reported. In another example, only the strongest beam is reported in the request. The report can be either a periodic or an aperiodic report. The sidelink beam pairing request contents include beam reporting timing. A time gap is reported that includes one of an upper bound or lower bound between sidelink CSI RS transmission and sidelink beam reporting. The timing reporting includes one report per sidelink CSI-RS or one report for multiple sidelink CSI-RSs.

The sidelink beam pairing pattern index specifies a configuration of the sidelink CSI-RS resources. The sidelink CSI-RS resources can be configured as follows. The sidelink CSI-RS resources can be periodic, semi-persistent, or aperiodic. The sidelink CSI-RS resources can indicate beam measurement timing. The beam measurement timing includes the time gap (e.g., an upper bound or a lower bound) between the sidelink beam pairing request and the sidelink CSI-RS transmission.

The list of sidelink beam pairing patterns are configured in advance of sidelink transmissions. The list of sidelink beam pairing patterns are configured either by resource pool messaging or by PC5-RRC messaging.

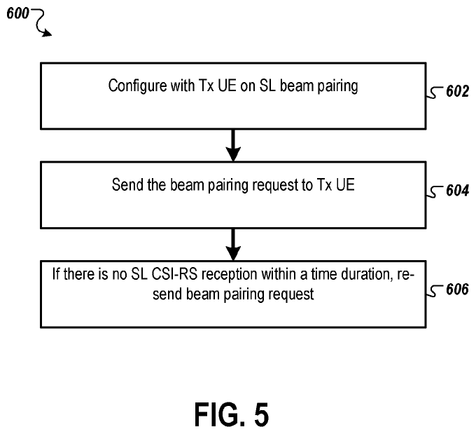

FIG. 5 shows an example process 500 for sidelink beam pairing request retransmission. For process 600, the sidelink beam pairing request can be triggered if a UE (either the Tx UE or the Rx UE) has some sidelink data to transmit. The corresponding UE transmits the sidelink beam pairing request such that the request included with the sidelink data transmission. After sending sidelink beam pairing request, the given UE is expected to receive sidelink CSI-RS for beam measurement within a certain time duration. If that UE has not received sidelink CSI-RS within the time duration, then the UE retransmits the sidelink beam pairing request. The time duration may be pre-defined, (pre)configured per resource pool, or dynamically indicated in the sidelink beam pairing request. For example, in an example for retransmitting the sidelink beam paring request, the Rx UE configures (602) with the Tx UE on the sidelink beam pairing. The Rx UE sends (604) the beam pairing request to the Tx UE with the sidelink data. The Rx UE resends (606) the beam pairing request if there is no sidelink CSI-RS reception within a specified time period (duration).

The UE that is (re)transmitting the sidelink beam pairing request selects resources for the (re)transmission. The resource selection for sidelink beam pairing request (re)transmission is performed as follows. The (re)transmission is based on a priority of the transmission of sidelink beam pairing request. The priority is based on the container used to send the sidelink beam pairing request. For example, if the sidelink beam pairing request is sent by a MAC CE (e.g., the sidelink beam pairing request MAC CE 400 of FIG. 4), the priority of sidelink beam pairing request MAC CE is one of the following options. The priority can be pre-defined (e.g., fixed to 1). The priority value can be (pre)configured per resource pool. In another example, the sidelink beam pairing request is sent using a MAC CE and is also sent with other sidelink data transmission to piggyback this transmission. In this case, the priority is selected as the higher priority between the sidelink data that is being piggybacked and the sidelink beam pairing request MAC CE that is being transmitted for resource selection. In another example, the sidelink beam pairing request is sent by SCI. In this case, the priority value is pre-defined or defined based on a resource pool (pre)configured priority value. In another example, the sidelink beam pairing request is sent via SCI and is transmitted with another sidelink data transmission. In this case, the priority value is selected from the higher priority value between the sidelink data and the (pre)configured priority value.

The packet delay budget (PDB) of the sidelink beam pairing request can be defined as follows. In a first example, the PDB is (pre)configured per resource pool. In a second example, the PDB is defined based on the PC5-RRC configuration. In a third example, the PDB is based on the PDB of the data to be transmitted/received after beam management occurs.

The sidelink beam determination is performed as follows. The sidelink beam determination can be at the Tx UE or at the Rx UE, depending on which previously described procedure for requesting the sidelink beam pairing (e.g., processes 300, 32) is applied. The UE that makes the decision on selecting the beam has the data specifying beam strength for each candidate beam. The UE (either the Rx UE or the Tx UE) selects a beam with a strongest strength (RSRP), such as if the measured RSRP is larger than a threshold value. The UE may not select a beam if the measured RSRP for each candidate beam does not satisfy a threshold value. The RSRP threshold can be (pre)configured per resource pool. The RSRP threshold can be configured using PC5-RRC signaling.

The sidelink beam determination can be performed as part of process 300 or process 320, previously described. For example, the sidelink beam determination can be performed as part of step 308 of process 300 or step 328 of process 320. The sidelink beam determination can be performed as part of process 500 or process 520, subsequently described. For example, the sidelink beam determination can be performed as part of step 528 of process 520.

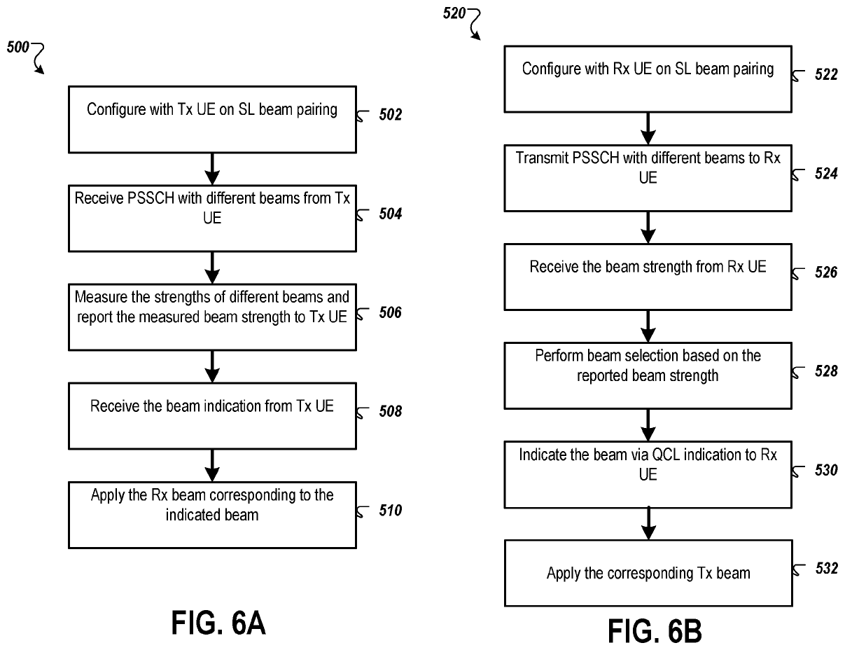

FIGS. 6A-6B illustrate respective flow diagrams of example processes 500, 520 for exemplary beam pairing procedures that specify how beam indication is performed. In process 500 of FIG. 6A, the Rx UE configures (502) the sidelink beam pairing with the Tx UE on the sidelink omnidirectional beam. The Rx UE receives (504) the PSSCH transmission that includes different beams from the Tx UE. The Rx UE measures (506) the strengths of different beams and reports the measured beam strength to the Tx UE. The Rx UE receives (508) the selected beam indication from Tx UE. The Rx UE applies (510) the Rx beam that corresponds to the indicated beam for sidelink transmissions. These steps are subsequently described in further detail.

The sidelink beam indication process 520 for the Tx UE is now described. In process 520 of FIG. 6B, the Tx UE configures (522) the sidelink beam pairing with the Rx UE on the sidelink omnidirectional beam. The Tx UE transmits (524) the PSSCH transmission that includes different beams to the Rx UE. The Tx UE receives (526) the measurements of the beam strengths of different beams from the Rx UE. The Tx UE performs (528) beam selection based on the reported beam strength measurements of different beams from the Rx UE. The Tx UE indicates (530) the selected beam to the Rx UE by quasi-colocation (QCL) messaging. The Tx UE applies (532) the corresponding Tx beam for the selected beam. These steps are subsequently described in further detail.

The sidelink beam indication is configured as now described. Specifically, the sidelink beam indication signaling can include the following examples for content, container format, transmission priority and timing configuration, beam selection for transmission, and PDB.

The sidelink beam indication contents include the following. The sidelink beam indication can include only new beam identifier, and not additional data or information related to other beams. In some implementations, the beam identifier is sent with the corresponding RSRP measurement for the identified beam. In some implementations, no new beam is selected or detected. In this case, the sidelink beam indication includes an invalid beam identifier.

The sidelink beam indication container can include one of the following. The container can include a MAC CE. The container can include a SCI stage 1 or a SCI stage 2 message. These are configured in a manner similar to that described previously with respect to the sidelink beam pairing request.

The transmission of the sidelink beam indicator can be as follows. The priority can be determined in a manner similar to the sidelink beam pairing request. For example, the priority is based on the container used to send the sidelink beam indicator. For example, if the sidelink beam indicator is sent by a MAC CE (e.g., the sidelink beam request MAC CE 400 of FIG. 4), the priority of sidelink beam indicator MAC CE is one of the following options. The priority can be pre-defined (e.g., fixed to 1). The priority value can be (pre)configured per resource pool. In another example, the sidelink beam indicator is sent using a MAC CE and is also sent with other sidelink data transmission to piggyback this transmission. In this case, the priority is selected as the higher priority between the sidelink data that is being piggybacked and the sidelink beam indicator MAC CE that is being transmitted for resource selection. In another example, the sidelink beam indicator is sent by SCI. In this case, the priority value is pre-defined or defined based on a resource pool (pre)configured priority value. In another example, the sidelink beam indicator is sent via SCI and is transmitted with another sidelink data transmission. In this case, the priority value is selected from the higher priority value between the sidelink data and the (pre)configured priority value.

The packet delay budget (PDB) of the sidelink beam indicator can be defined as follows. In a first example, the PDB is (pre)configured per resource pool. In a second example, the PDB is defined based on the PC5-RRC configuration. In a third example, the PDB is based on the PDB of the data to be transmitted/received after beam management occurs.

The transmission beam for the sidelink indicator can be as follows. The transmission beam can be an omnidirectional beam. In another example, the transmission beam is associated with the sidelink beam indication identifier. For example, the transmission beam can be associated with the beam identifier in the CSI-RS configuration in the control signal. The identifier indicates in the control signal which beam is being used.

The sidelink beam indication can be performed as part of process 300 or process 320, previously described. For example, the sidelink beam indication can be performed as part of step 308 of process 300 or step 328 of process 320. The sidelink beam indication can be performed as part of process 500 or process 520, previously described. For example, the sidelink beam determination can be performed as part of step 508 of process 500 or step 530 of process 520.

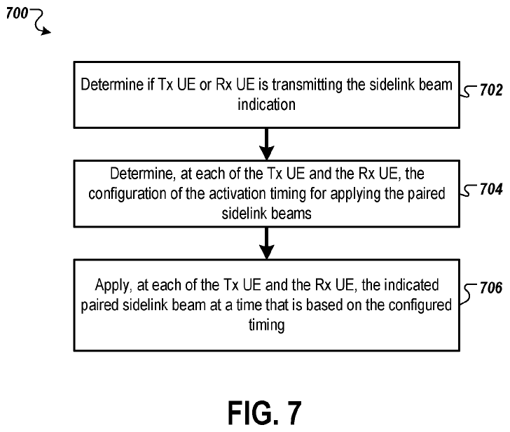

FIG. 7 shows an example process 700 for activation of the paired sidelink beams by the Tx UE and the Rx UE. The process 700 includes determining whether the Tx UE or the Rx UE is transmitting the sidelink beam indication. Each UE selects the sidelink beam of the beam pair for activation based on which UE transmitted the indicator, as subsequently described. The Rx UE and the Tx UE each determine (704) a configuration of the activation timing for applying the paired sidelink beams. The timing specifies when the beam is applied at each UE and is generally relative to the receipt of an ACK signal, or other baseline, confirming the beam pair from the other respective UE. The process 700 includes applying (706), at each of the Tx UE and the Rx UE, the indicated paired sidelink beam. The paired beams are activated at a time that is based on the timing configuration data. The timing is configured as subsequently described.

Scenarios for the activation of the sidelink beams are now described. The Tx UE and the Rx UE perform activation based on which UE receives or transmits the sidelink beam indication. In a first example, the Tx UE receives the sidelink beam indication. The Tx UE applies the transmission beam indicated in the beam indication. In this example, the Rx UE transmits the sidelink beam indication. The Rx UE then applies the receiver beam associated with the beam indication. In another example, the Tx UE transmits the sidelink beam indication. The Tx UE then applies the transmission beam indicated in the beam indication. In this example, the Rx UE transmits the sidelink beam reporting and receives the sidelink beam indication. The Rx UE applies the receiver beam associated with the beam indication. Generally, the signaling is based on the transmission beam, and the Rx beam configured to correspond to the Tx beam. The Rx UE does not need the Rx beam to be indicated, as the Rx beam corresponding to the Tx beam is already known.

The sidelink beam activation can be performed as part of process 300 or process 320, previously described. For example, the sidelink beam activation can be performed as part of step 310 of process 300 or step 330 of process 320. The sidelink beam activation can be performed as part of process 500 or process 520, previously described. For example, the sidelink beam determination can be performed as part of step 510 of process 500 or step 532 of process 520.

The timing of applying paired sidelink beam is in accordance with one or more of the following examples. In a first implementation, the timing of the application of the paired sidelink beam is based on a (pre)defined configured. For example, the timing can be 3 milliseconds (ms) after receipt of an acknowledgement (ACK) of the sidelink beam indication. In a second implementation, the timing of the application of the paired sidelink beam is (pre)configured per resource pool. For example, a time gap between the sidelink beam indication receipt and application of the paired sidelink beam can be configured to be 3 ms. In another example, the time gap between the receipt of the ACK signal responsive to sidelink beam indication and application of the paired sidelink beam is set at 3 ms. In a third implementation, the timing is configured per PC5-RRC signaling. The timing is set as part of negotiation between UEs. In a fourth implementation, the UE capability governs the timing. The UE capability for each of the Tx and Rx UEs is indicated in the UE's negotiation procedure. In a fifth implementation, the activation timing for the paired sidelink beam is indicated in the sidelink beam reporting or sidelink beam indication message itself. Either the SCI message or the MAC CE indicates timing for application of the paired sidelink beam.

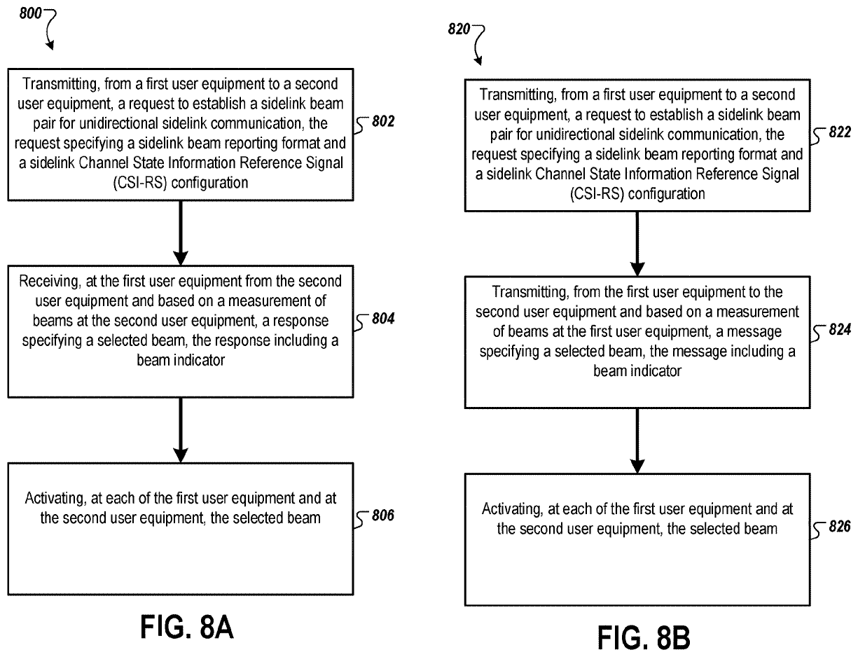

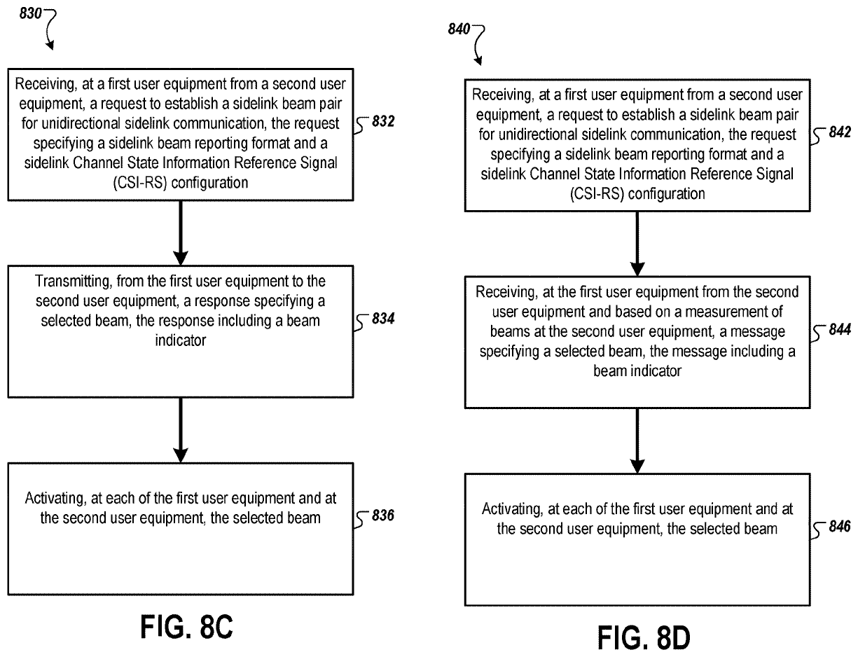

FIG. 8A illustrates a flowchart of an example method 800, according to some implementations. For clarity of presentation, the description that follows generally describes method 800 in the context of the other figures in this description. For example, method 800 can be performed by UEs 105 of FIG. 1. It will be understood that method 800 can be performed, for example, by any suitable system, environment, software, hardware, or a combination of systems, environments, software, and hardware, as appropriate. In some implementations, various steps of method 800 can be run in parallel, in combination, in loops, or in any order.

Process 800 includes transmitting (802), from a first user equipment to a second user equipment, a request to establish a sidelink beam pair for unidirectional sidelink communication, the request specifying a sidelink beam reporting format and a sidelink Channel State Information Reference Signal (CSI-RS) configuration. Process 800 includes receiving (804), at the first user equipment from the second user equipment, a response specifying a selected beam, the response including a beam indicator. Process 800 includes activating (806), at each of the first user equipment and at the second user equipment, the selected beam.

FIG. 8B illustrates a flowchart of an example method 820, according to some implementations. For clarity of presentation, the description that follows generally describes method 820 in the context of the other figures in this description. For example, method 820 can be performed by UEs 105 of FIG. 1. It will be understood that method 820 can be performed, for example, by any suitable system, environment, software, hardware, or a combination of systems, environments, software, and hardware, as appropriate. In some implementations, various steps of method 820 can be run in parallel, in combination, in loops, or in any order.

Process 820 includes transmitting (822), from a first user equipment to a second user equipment, a request to establish a sidelink beam pair for unidirectional sidelink communication, the request specifying a sidelink beam reporting format and a sidelink Channel State Information Reference Signal (CSI-RS) configuration. Process 820 includes transmitting (824), from the first user equipment to the second user equipment and based on a measurement of beams at the first user equipment, a message specifying a selected beam, the message including a beam indicator. Process 820 includes activating (826), at each of the first user equipment and at the second user equipment, the selected beam.

FIG. 8C illustrates a flowchart of an example method 830, according to some implementations. For clarity of presentation, the description that follows generally describes method 830 in the context of the other figures in this description. For example, method 830 can be performed by UEs 105 of FIG. 1. It will be understood that method 830 can be performed, for example, by any suitable system, environment, software, hardware, or a combination of systems, environments, software, and hardware, as appropriate. In some implementations, various steps of method 830 can be run in parallel, in combination, in loops, or in any order.

Process 830 includes receiving (832), at a first user equipment from a second user equipment, a request to establish a sidelink beam pair for unidirectional sidelink communication, the request specifying a sidelink beam reporting format and a sidelink Channel State Information Reference Signal (CSI-RS) configuration. Process 830 includes transmitting (834), from the first user equipment to the second user equipment, a response specifying a selected beam, the response including a beam indicator. Process 830 includes activating (836), at each of the first user equipment and at the second user equipment, the selected beam.

FIG. 8D illustrates a flowchart of an example method 840, according to some implementations. For clarity of presentation, the description that follows generally describes method 840 in the context of the other figures in this description. For example, method 840 can be performed by UEs 105 of FIG. 1. It will be understood that method 840 can be performed, for example, by any suitable system, environment, software, hardware, or a combination of systems, environments, software, and hardware, as appropriate. In some implementations, various steps of method 840 can be run in parallel, in combination, in loops, or in any order.

Process 840 includes receiving (842), at a first user equipment from a second user equipment, a request to establish a sidelink beam pair for unidirectional sidelink communication, the request specifying a sidelink beam reporting format and a sidelink Channel State Information Reference Signal (CSI-RS) configuration. Process 840 includes receiving (844), at the first user equipment from the second user equipment and based on a measurement of beams at the second user equipment, a message specifying a selected beam, the message including a beam indicator. Process 840 includes activating (846), at each of the first user equipment and at the second user equipment, the selected beam.

Processes 800, 820, 830, and 840 can include one or more of the following implementations. In some implementations, one or more of the processes 800, 820, 830, and 840 include performing, at the first user equipment, a reference signals received power (RSRP) measurement on a sidelink transmission received from the second user equipment. In some implementations, one or more of the processes 800, 820, 830, and 840 include triggering, by the first user equipment based on the RSRP measurement, transmission of the request to establish the sidelink beam pair to the second user equipment.

In some implementations, one or more of the processes 800, 820, 830, and 840 incdlue receiving, at the first user equipment, hybrid automatic repeat request (HARQ) feedback for sidelink transmissions with the second user equipment, the HARQ feedback including a number of acknowledgement (ACK) instances or a number of negative acknowledgement (NACK) instances. In some implementations, one or more of the processes 800, 820, 830, and 840 include triggering, by the first user equipment based on the HARQ feedback, transmission of the request to establish the sidelink beam pair to the second user equipment. In some implementations, the triggering occurs when the number of ACK instances is below a threshold percentage of total instances or is below a threshold number of instances. In some implementations, the triggering occurs when the number of NACK instances satisfies a threshold percentage of total instances or satisfies a threshold number of instances.

In some implementations, the first user equipment includes a receiving (Rx) user equipment, and wherein the Rx user equipment transmits a sidelink beam pairing request to the second user equipment that includes a transmitting (Tx) user equipment.

In some implementations, the request to establish a sidelink beam pair for unidirectional sidelink communication comprises a sidelink beam pairing pattern index. In some implementations, the sidelink beam pairing pattern index comprises a sidelink beam reporting format. In some implementations, the sidelink beam reporting format specifies one of L1-RSRP or L1-SINR based reporting or beam index reporting. In some implementations, the sidelink beam reporting format specifies a number of beams to be reported. In some implementations, the sidelink beam reporting format specifies periodic reporting. In some implementations, the sidelink beam reporting format specifies aperiodic reporting. In some implementations, the sidelink beam reporting format specifies a time gap upper bound or a time gap lower bound for beam reporting timing, the time gap being between sidelink CSI-RS transmission and sidelink beam reporting. In some implementations, the sidelink beam reporting format specifies a number of reports per sidelink CSI-RS transmissions. In some implementations, the sidelink beam pairing pattern index specifies a configuration for sidelink CSI-RS resources for reporting.

In some implementations, one or more of the processes 800, 820, 830, and 840 include retransmitting, by the first user equipment, the request to establish a sidelink beam pair for unidirectional sidelink communication, the retransmitting occurring when the first user equipment does not receive a sidelink CSI-RS within a time duration. In some implementations, the time duration is pre-defined. In some implementations, the time duration is defined per a resource pool or is indicated in the request to establish the sidelink beam pair.

In some implementations, one or more of the processes 800, 820, 830, and 840 include transmitting the request to establish a sidelink beam pair when the first user equipment identifies additional sidelink data to transmit to the second user equipment, the request being included in the transmission of the additional sidelink data.

In some implementations, the selected beam is associated with an RSRP value that is higher than one or more other beams or exceeds a threshold RSRP value or both.

In some implementations, the threshold RSRP value is configured per a resource pool or is configured by radio resource control (RRC) signaling.

In some implementations, the request to establish a sidelink beam pair for unidirectional sidelink communication comprises a medium access control (MAC) control element (CE).

In some implementations, the request to establish a sidelink beam pair for unidirectional sidelink communication comprises a SCI stage 1 container.

In some implementations, the request to establish a sidelink beam pair for unidirectional sidelink communication comprises a SCI stage 2 container having a format 2-A, 2-C, or 2-D.

In some implementations, the request to establish a sidelink beam pair for unidirectional sidelink communication is associated with a priority value, the priority value being based on a container including the request. In some implementations, the container includes a MAC CE, and wherein the priority value is selected from a higher priority between a first priority of the MAC CE and a second priority of sidelink data transmitted with the MAC CE. In some implementations, the container includes SCI, and wherein the priority value is selected from a higher priority between a first priority of sidelink data transmitted with the SCI and a second priority value that is (pre)configured.

In some implementations, a packet delay budget (PDB) of the request to establish a sidelink beam pair for unidirectional sidelink communication is based on RRC configuration.

In some implementations, a packet delay budget (PDB) of the request to establish a sidelink beam pair for unidirectional sidelink communication is based on PDB of sidelink data for transmitting over the sidelink beam pair.

In some implementations, applying, at each of the first user equipment and at the second user equipment, the selected beam, is based on a preconfigured timing after the second user equipment receives an acknowledgement from the first user equipment of the response including the beam indicator.

The example methods 800, 820, 830, 840 shown in FIGS. 8A-8D can be modified or reconfigured to include additional, fewer, or different steps (not shown in FIGS. 8A-8D), which can be performed in the order shown or in a different order.

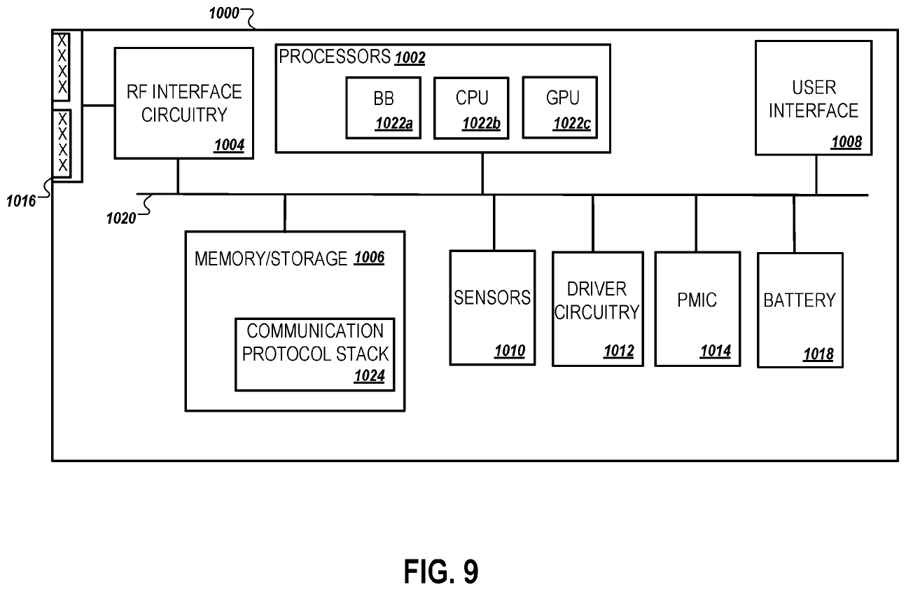

FIG. 9 illustrates an example UE 1000, according to some implementations. The UE 1000 may be similar to and substantially interchangeable with UEs 105 of FIG. 1.

The UE 1000 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

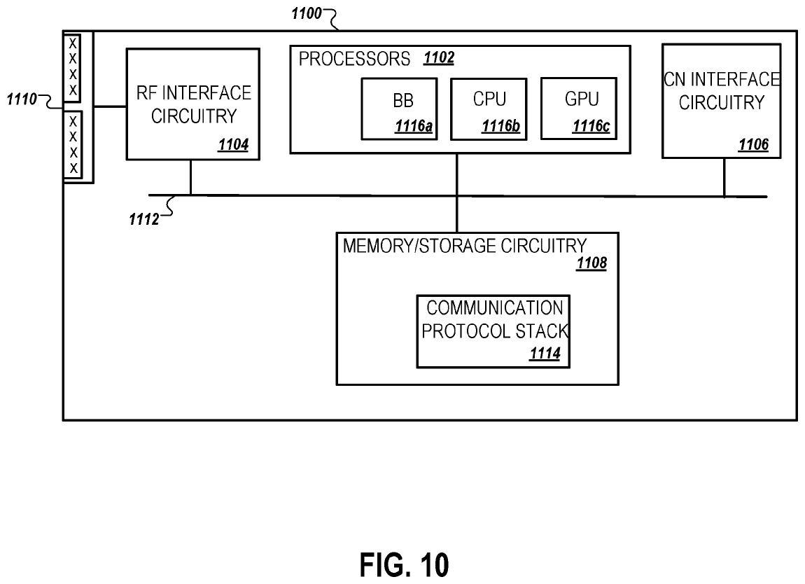

The UE 1000 may include processors 1002, RF interface circuitry 1004, memory/storage 1006, user interface 1008, sensors 1010, driver circuitry 1012, power management integrated circuit (PMIC) 1014, one or more antenna(s) 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1016. In various implementations, the RF interface circuitry 1004 may be configured to transmit/receive signals in a manner compatible with NR access technologies.

The antenna(s) 1016 may include one or more antenna elements to convert electrical signals into radio waves to travel through the air and to convert received radio waves into electrical signals. The antenna elements may be arranged into one or more antenna panels. The antenna(s) 1016 may have antenna panels that are omnidirectional, directional, or a combination thereof to enable beamforming and multiple input, multiple output communications. The antenna(s) 1016 may include microstrip antennas, printed antennas fabricated on the surface of one or more printed circuit boards, patch antennas, phased array antennas, etc. The antenna(s) 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensors 1010 and control and allow access to sensors 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

FIG. 10 illustrates an example access node 1100 (e.g., a base station or gNB), according to some implementations. The access node 1100 may be similar to and substantially interchangeable with base stations 110. The access node 1100 may include processors 1102, RF interface circuitry 1104, core network (CN) interface circuitry 1106, memory/storage circuitry 1108, and one or more antenna(s) 1110.

The components of the access node 1100 may be coupled with various other components over one or more interconnects 1112. The processors 1102, RF interface circuitry 1104, memory/storage circuitry 1108 (including communication protocol stack 1114), antenna(s) 1110, and interconnects 1112 may be similar to like-named elements shown and described with respect to FIG. 10. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In V2X scenarios, the access node 1100 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

### Examples

Example 1 includes a method including: transmitting, from a first user equipment to a second user equipment, a request to establish a sidelink beam pair for unidirectional sidelink communication, the request specifying a sidelink beam reporting format and a sidelink Channel State Information Reference Signal (CSI-RS) configuration; transmitting, from the first user equipment to the second user equipment and based on a measurement of beams at the first user equipment, a message specifying a selected beam, the message including a beam indicator; and activating, at the first user equipment, the selected beam.
Example 2 is the method of Example 1, further including performing, at the first user equipment, a reference signals received power (RSRP) measurement on a sidelink transmission received from the second user equipment; and triggering, by the first user equipment based on the RSRP measurement, transmission of the request to establish the sidelink beam pair to the second user equipment.
Example 3 is the method of Example 1 or 2, further comprising receiving, at the first user equipment, hybrid automatic repeat request (HARQ) feedback for sidelink transmissions with the second user equipment, the HARQ feedback including a number of acknowledgement (ACK) instances or a number of negative acknowledgement (NACK) instances; and triggering, by the first user equipment based on the HARQ feedback, transmission of the request to establish the sidelink beam pair to the second user equipment.
Example 4 is the method of Example 3, wherein the triggering occurs when the number of ACK instances is below a threshold percentage of total instances or is below a threshold number of instances.
Example 5 is the method of Example 3, wherein the triggering occurs when the number of NACK instances satisfies a threshold percentage of total instances or satisfies a threshold number of instances.
Example 6 is the method of Examples 1 to 5, wherein the first user equipment includes a receiving (Rx) user equipment, and wherein the Rx user equipment transmits a sidelink beam pairing request to the second user equipment that includes a transmitting (Tx) user equipment.
Example 7 is the method of Examples 1 to 6, wherein the request to establish a sidelink beam pair for unidirectional sidelink communication comprises a sidelink beam pairing pattern index.
Example 8 is the method of Examples 1 to 7, wherein the sidelink beam pairing pattern index comprises a sidelink beam reporting format.
Example 9 is the method of Example 8, wherein the sidelink beam reporting format specifies one of L1-RSRP or L1-SINR based reporting or beam index reporting.
Example 10 is the method of Example 8, wherein the sidelink beam reporting format specifies a number of beams to be reported.
Example 11 is the method of Example 8, wherein the sidelink beam reporting format specifies periodic reporting.
Example 12 is the method of Example 8, wherein the sidelink beam reporting format specifies aperiodic reporting.
Example 13 is the method of Example 8, wherein the sidelink beam reporting format specifies a time gap upper bound or a time gap lower bound for beam reporting timing, the time gap being between sidelink CSI-RS transmission and sidelink beam reporting.
Example 14 is the method of Example 8, wherein the sidelink beam reporting format specifies a number of reports per sidelink CSI-RS transmissions.
Example 15 is the method of Example 7, wherein the sidelink beam pairing pattern index specifies a configuration for sidelink CSI-RS resources for reporting.
Example 16 is the method of any of Examples 1 to 15, further including retransmitting, by the first user equipment, the request to establish a sidelink beam pair for unidirectional sidelink communication, the retransmitting occurring when the first user equipment does not receive a sidelink CSI-RS within a time duration.
Example 17 is the method of Example 16, wherein the time duration is pre-defined.
Example 18 is the method of Example 16, wherein the time duration is defined per a resource pool or is indicated in the request to establish the sidelink beam pair.
Example 19 is the method of any of Examples 1 to 18, further including transmitting the request to establish a sidelink beam pair when the first user equipment identifies additional sidelink data to transmit to the second user equipment, the request being included in the transmission of the additional sidelink data.
Example 20 is the method of any of Examples 1 to 19, wherein the selected beam is associated with an RSRP value that is higher than one or more other beams or exceeds a threshold RSRP value or both.
Example 21 is the method of any of Examples 1 to 20, wherein the threshold RSRP value is configured per a resource pool or is configured by radio resource control (RRC) signaling.
Example 22 is the method of any of Examples 1 to 21, wherein the request to establish a sidelink beam pair for unidirectional sidelink communication comprises a medium access control (MAC) control element (CE).
Example 23 is the method of any of Examples 1 to 22, wherein the request to establish a sidelink beam pair for unidirectional sidelink communication comprises a SCI stage 1 container.
Example 24 is the method of any of Examples 1 to 23, wherein the request to establish a sidelink beam pair for unidirectional sidelink communication comprises a SCI stage 2 container having a format 2-A, 2-C, or 2-D.
Example 25 is the method of any of Examples 1 to 24, wherein the request to establish a sidelink beam pair for unidirectional sidelink communication is associated with a priority value, the priority value being based on a container including the request.
Example 26 is the method of Example 25, wherein the container includes a MAC CE, and wherein the priority value is selected from a higher priority between a first priority of the MAC CE and a second priority of sidelink data transmitted with the MAC CE.
Example 27 is the method of Example 25, wherein the container includes SCI, and wherein the priority value is selected from a higher priority between a first priority of sidelink data transmitted with the SCI and a second priority value that is (pre)configured.
Example 28 is the method of any of Examples 1 to 27, wherein a packet delay budget (PDB) of the request to establish a sidelink beam pair for unidirectional sidelink communication is based on RRC configuration.
Example 29 is the method of any of Examples 1 to 28, wherein a packet delay budget (PDB) of the request to establish a sidelink beam pair for unidirectional sidelink communication is based on PDB of sidelink data for transmitting over the sidelink beam pair.
Example 30 is the method of any of Examples 1 to 29, wherein applying, at each of the first user equipment and at the second user equipment, the selected beam, is based on a preconfigured timing after the second user equipment receives an acknowledgement from the first user equipment of the response including the beam indicator.
Example 31 is a method comprising: transmitting, from a first user equipment to a second user equipment, a request to establish a sidelink beam pair for unidirectional sidelink communication, the request specifying a sidelink beam reporting format and a sidelink Channel State Information Reference Signal (CSI-RS) configuration; receiving, at the first user equipment from the second user equipment, a response specifying a selected beam, the response including a beam indicator; and applying, at the first user equipment, the selected beam.
Example 32 is a method comprising receiving, at a first user equipment from a second user equipment, a request to establish a sidelink beam pair for unidirectional sidelink communication, the request specifying a sidelink beam reporting format and a sidelink Channel State Information Reference Signal (CSI-RS) configuration; transmitting, from the first user equipment to the second user equipment, a response specifying a selected beam, the response including a beam indicator; and applying, at the first user equipment, the selected beam.
Example 33 is a method comprising receiving, at a first user equipment from a second user equipment, a request to establish a sidelink beam pair for unidirectional sidelink communication, the request specifying a sidelink beam reporting format and a sidelink Channel State Information Reference Signal (CSI-RS) configuration; receiving, at the first user equipment from the second user equipment and based on a measurement of beams at the second user equipment, a message specifying a selected beam, the message including a beam indicator; and applying, at the first user equipment, the selected beam.
Example 34 may include an apparatus including logic, modules, and/or circuitry (e.g., processing circuitry) to perform one or more elements of a method described in or related to any of examples 1-33, or any other method or process described herein.
Example 35 may include a method, technique, or process as described in or related to any of examples 1-33, or portions or parts thereof.
Example 36 may include an apparatus including: one or more processors and one or more computer-readable media including instructions that, when executed by the one or more processors, cause the one or more processors to perform the method, techniques, or process as described in or related to any of examples 1-33, or portions thereof.
Example 37 may include a signal as described in or related to any of examples 1-33, or portions or parts thereof.
Example 38 may include a computer program including instructions, wherein execution of the program by a processing element is to cause the processing element to carry out the method, techniques, or process as described in or related to any of examples 1-45, or portions thereof. The operations or actions performed by the instructions executed by the processing element can include the methods of any one of examples 1-33.
Example 39 may include a method of communicating in a wireless network as shown and described herein.
Example 40 may include a system for providing wireless communication as shown and described herein. The operations or actions performed by the system can include the methods of any one of examples 1-33.
Example 41 may include a device for providing wireless communication as shown and described herein. The operations or actions performed by the device can include the methods of any one of examples 1-33.

The previously-described examples 1-33 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-35. (canceled)

36. One or more processors configured to cause a first user equipment (UE) to perform operations comprising:
transmitting to a second user equipment, a request to establish a sidelink beam pair for unidirectional sidelink communication, the request specifying a sidelink beam reporting format and a sidelink Channel State Information Reference Signal (CSI-RS) configuration;
transmitting, to the second user equipment and based on a measurement of beams, a message specifying a selected beam, the message including a beam indicator; and
activating, at the first user equipment, the selected beam.

37. The one or more processors of claim 36, the operations further comprising:
performing a reference signals received power (RSRP) measurement on a sidelink transmission received from the second user equipment; and
triggering, based on the RSRP measurement, transmission of the request to establish the sidelink beam pair to the second user equipment.

38. The one or more processors of claim 36, the operations further comprising:
receiving hybrid automatic repeat request (HARQ) feedback for sidelink transmissions with the second user equipment, the HARQ feedback including a number of acknowledgement (ACK) instances or a number of negative acknowledgement (NACK) instances; and
triggering, based on the HARQ feedback, transmission of the request to establish the sidelink beam pair to the second user equipment.

39. The one or more processors of claim 38, wherein the triggering occurs when the number of ACK instances is below a threshold percentage of total instances or is below a threshold number of instances, or
wherein the triggering occurs when the number of NACK instances satisfies a threshold percentage of total instances or satisfies a threshold number of instances.

40. The one or more processors of claim 36, wherein the request to establish a sidelink beam pair for unidirectional sidelink communication comprises a sidelink beam pairing pattern index.

41. The one or more processors of claim 40, wherein the sidelink beam pairing pattern index comprises a sidelink beam reporting format.

42. The one or more processors of claim 41, wherein the sidelink beam reporting format specifies i) one of L1-RSRP or L1-SINR based reporting or beam index reporting, ii) a number of beams to be reported, iii) a periodic reporting configuration or an aperiodic reporting configuration, iv) a time gap upper bound or a time gap lower bound for beam reporting timing, the time gap being between sidelink CSI-RS transmission and sidelink beam reporting, v) a number of reports per sidelink CSI-RS transmissions, or vi) a combination of i), ii), iii), iv), and v).

43. The one or more processors of claim 40, wherein the sidelink beam pairing pattern index specifies a configuration for sidelink CSI-RS resources for reporting.

44. The one or more processors of claim 36, the operations further comprising:
retransmitting the request to establish a sidelink beam pair for unidirectional sidelink communication, the retransmitting occurring a sidelink CSI-RS is not received within a time duration.

45. The one or more processors of claim 44, wherein the time duration is defined per a resource pool or is indicated in the request to establish the sidelink beam pair.

46. The one or more processors of claim 36, the operations further comprising:
transmitting the request to establish a sidelink beam pair when additional sidelink data is identified for transmission to the second user equipment, the request being included in a transmission of the additional sidelink data.

47. The one or more processors of claim 36, wherein the selected beam is associated with an RSRP value that is higher than one or more other beams or exceeds a threshold RSRP value or both.

48. The one or more processors of claim 36, wherein the request to establish a sidelink beam pair for unidirectional sidelink communication is associated with a priority value, the priority value being based on a container including the request.

49. The one or more processors of claim 48, wherein the container includes a MAC CE, and wherein the priority value is selected from a higher priority between a first priority of the MAC CE and a second priority of sidelink data transmitted with the MAC CE.

50. The one or more processors of claim 48, wherein the container includes SCI, and wherein the priority value is selected from a higher priority between a first priority of sidelink data transmitted with the SCI and a second priority value that is (pre)configured.

51. The one or more processors of claim 36, wherein a packet delay budget (PDB) of the request to establish a sidelink beam pair for unidirectional sidelink communication is based on RRC configuration.

52. The one or more processors of claim 36, wherein a packet delay budget (PDB) of the request to establish a sidelink beam pair for unidirectional sidelink communication is based on PDB of sidelink data for transmitting over the sidelink beam pair.

53. The one or more processors of claim 36, wherein applying the selected beam is based on a preconfigured timing after the second user equipment receives an acknowledgement from the first user equipment of the message including the beam indicator.

54. An apparatus comprising:
a transceiver;
one or more processors; and
a memory storing instructions that, when executed by the one or more processors, cause the one or more processors to perform operations comprising:
encoding, for transmission by the transceiver to a second user equipment, a request to establish a sidelink beam pair for unidirectional sidelink communication, the request specifying a sidelink beam reporting format and a sidelink Channel State Information Reference Signal (CSI-RS) configuration;
decoding a response, received from the second user equipment via the transceiver, the response specifying a selected beam, the response including a beam indicator; and
applying the selected beam.

55. A method for wireless communication, the method comprising:
receiving, at a first user equipment from a second user equipment, a request to establish a sidelink beam pair for unidirectional sidelink communication, the request specifying a sidelink beam reporting format and a sidelink Channel State Information Reference Signal (CSI-RS) configuration;
transmitting, from the first user equipment to the second user equipment, a response specifying a selected beam, the response including a beam indicator; and
applying, at the first user equipment, the selected beam.
